(19) United States
(12) Patent Application Publication
(10) Pub. No.: US 2024/0217849 A1
(43) Pub. Date: Jul. 4, 2024

(54) Sodium Hypochlorite Generator with Water Salinity Detection Device

(71) Applicant: Guangzhou Rising Dragon Recreation Industrial Co., Ltd., Guangzhou (CN)

(72) Inventors: Ziqin GUO, Guangzhou (CN); Bo LIANG, Guangzhou (CN); Yun CHEN, Guangzhou (CN); Bo PENG, Guangzhou (CN)

(73) Assignee: Guangzhou Rising Dragon Recreation Industrial Co., Ltd., Guangzhou, GD (CN)

(21) Appl. No.: 18/473,319

(22) Filed: Sep. 25, 2023

(30) Foreign Application Priority Data
Dec. 28, 2022 (CN) 202223513040.5

(51) Int. Cl. C02F 1/68; C02F 1/461; C25B 1/26; G01N 27/00

(52) U.S. Cl. CPC C02F 1/686; C02F 1/46109; C25B 1/26; G01N 27/002; C02F 2303/04

(57) ABSTRACT

A sodium hypochlorite generator includes a sodium hypochlorite generation device disposed in a pre-buried wall hole formed in a wall, and a water salinity detection device electrically connected to the sodium hypochlorite generation device. A first probe and a second probe disposed on a wireless power receiving device detect a voltage signal therebetween, and outputs the voltage signal into a detection box of the water salinity detection device through a signal line, a drive module obtains the water salinity according to the voltage signal, and the water salinity is displayed by a display panel, such that the change of the concentration of a sodium chloride solution during reaction can be observed in real time to determine the extent of the electrolytic reaction, the time of the electrolytic reaction can be controlled easily, and time and energy costs are saved.

### FIELD

The invention relates to the field of disinfection and sterilization of water in outdoor massage bathtubs and swimming pools, in particular to a sodium hypochlorite generator.

### BACKGROUND

A sodium hypochlorite solution is often used for sterilization of swimming pools or bathtubs, is typically prepared by electrolyzing the sodium chloride solution, and has the advantages of being non-toxic, environmentally friendly, and good in disinfection and sterilization performance, thus being widely used.

Sodium hypochlorite generators are used for electrochemical preparation of sodium hypochlorite, and because gas will be produced both in the electrolytic reaction process of the sodium chloride solution and in the electrolytic reaction process of water, it is impossible to visually determine the extent of electrolytic reaction of the sodium chloride solution when the sodium chloride solution is electrolyzed in the sodium hypochlorite generators, making it difficult to control the electrolysis time, leading to time waste and energy penalty, and increasing electrolytic costs. Therefore, a novel sodium hypochlorite generator is needed.

### SUMMARY

The invention provides a sodium hypochlorite generator with a water salinity detection device, which can determine the degree of electrolysis of the sodium chloride solution by detecting the concentration range of the sodium chloride solution in water, thus solving the problem that the electrolysis time is difficult to control during electrolysis of sodium chloride.

In one aspect, the present invention provides a sodium hypochlorite generator which comprises a sodium hypochlorite generation device for being disposed in a pre-buried wall hole formed in a wall, and a water salinity detection device electrically connected to the sodium hypochlorite generation device. The sodium hypochlorite generation device comprises a cover, an electrode insert and a base with a receiving cavity, the electrode insert being detachably disposed in the receiving cavity of the base, the electrode insert comprising an insert body and a plurality of electrodes mounted on the insert body, the cover being fixedly mounted on the insert body. The water salinity detection device comprises a display panel, a detection box, a power line and a signal line. A wireless power receiving device is disposed in the insert body, a first probe and a second probe are disposed on the wireless power receiving device for detecting and outputting a voltage between the first and second probes. A wireless power transmitting device corresponding to the wireless power receiving device is disposed in the base. A drive module configured for obtaining the salinity of water according to the voltage is disposed in the detection box, the power line, one end of the signal line and the display panel are electrically connected to the drive module, the other end of the signal line is electrically connected to the wireless power transmitting device for receiving a voltage signal between the first probe and the second probe and transmitting the voltage signal to the drive module.

Preferably, a plurality of display lamps are disposed on the display panel and are used for indicating a salinity range of water.

Preferably, the detection box is provided with a protrusion extending towards the display panel, threaded holes are formed in the protrusion, and the detection box is fixedly connected to the display panel through screws fixed in the threaded holes.

Preferably, an external thread is disposed on an outer side of the detection box, and the detection box is for being fixedly mounted to a support through a locking nut.

Preferably, a groove is formed in a side, close to the display panel, of the protrusion, a bottom surface of the display panel abuts against and contacts with the groove to form a cavity, and a waterproof gasket is disposed in the cavity.

Preferably, a transmitting device receiving cavity is formed at a side, opposite to the insert receiving cavity, of the base, and the wireless power transmitting device is disposed in the transmitting device receiving cavity.

Preferably, the wireless power receiving device is electrically connected to the electrodes, the first probe and the second probe such that an external power supply is capable of driving the electrodes to perform electrolysis through the wireless power transmitting device and the wireless power receiving device, and synchronously drives the first probe and the second probe to detect and output the voltage between the first probe and the second probe.

Preferably, the sodium hypochlorite generation device further comprises a turbulent flow channel which penetrates through the base and the insert body to be fluidly communicated with a working space of the electrodes.

The invention has the following beneficial effect: the sodium hypochlorite generator with a water salinity detection device comprises a sodium hypochlorite generation device disposed in a pre-buried wall hole formed in a wall, and a water salinity detection device electrically connected to the sodium hypochlorite generation device; a first probe and a second probe disposed on a wireless power receiving device detect a voltage signal therebetween, and outputs the voltage signal into a detection box of the water salinity detection device through a signal line, a drive module obtains the water salinity according to the voltage signal, and the water salinity is displayed by a display panel, such that the change of the concentration of a sodium chloride solution during reaction can be observed in real time to determine the extent of the electrolytic reaction, the time of the electrolytic reaction can be controlled easily, and time and energy costs are saved.

### BRIEF DESCRIPTION OF THE DRAWINGS

FIG. 1 is a three-dimensional structural view of a sodium hypochlorite generation device according to the invention;

FIG. 2 is an exploded view of the sodium hypochlorite generation device according to the invention;

FIG. 3 is an enlarged view of part A in FIG. 2;

FIG. 4 is a structural view of an insert body according to the invention;

FIG. 5 is a three-dimensional structural view of a base according to the invention;

FIG. 6 is a bottom structural view of the base according to the invention;

FIG. 7 is a three-dimensional structural view of a water salinity detection device according to the invention;

FIG. 8 is a sectional structural view of the water salinity detection device according to the invention;

FIG. 9 is an exploded view of the water salinity detection device according to the invention;

FIG. 10 is a structural view of a detection box according to the invention; and

FIG. 11 illustrates a communication and electronic connection between components.

### REFERENCE SIGNS

1, sodium hypochlorite generation device; 11, cover; 111, through hole; 112, mounting hole C;
12, electrode insert; 121, insert body; 122, electrode; 123, wireless power receiving device; 1231, lug; 124, first probe; 125, second probe; 126, cylinder; 1261, cylinder cavity; 1262, mounting hole; 127, protrusion; 1271, threaded hole; 128, external thread; 129, mounting groove;
13, base; 131, insert receiving cavity; 132, transmitting device receiving cavity; 133, wireless power transmitting device; 1332, lug; 134, internal thread; 135, mounting hole; 136, external thread;
14, turbulent flow channel; 141, first channel; 142, second channel; 15, locking nut; 16, sealing gasket;
2, water salinity detection device; 21, display panel; 211, display lamp; 22, detection box; 221, external thread; 222, protrusion; 2221, threaded hole; 2222, groove; 2223, waterproof gasket; 23, power line; 24, signal line; 25, locking nut.
3, wall; 31,32, pre-buried wall hole.

### DESCRIPTION OF THE EMBODIMENTS

A sodium hypochlorite generator with a water salinity detection device provided by the invention will be further described below in conjunction with the accompanying drawings. It should be pointed out that the technical solution and design principle of the invention will be expounded below with reference to an optimal technical solution.

It should be noted that, in the whole description of the invention, nouns of locality such as terms including “centre”, “crosswise”, “lengthwise”, “lateral”, “length”, “width”, “thickness”, “upper”, “lower”, “front”, “back”, “left”, “right”. “vertical”, “perpendicular”. “horizontal”, “top”, “bottom”, “inner”, “outer”, “clockwise” and “anticlockwise” are used to indicate directional or positional relationships based on the accompanying drawings or to indicate directional or positional relationships commonly known by those skilled in the art merely for facilitating and simplifying the description of the invention, and do not imply that a device or element referred to must be in a specific direction, or be constructed and operated by a specific direction, so they should not be construed as limiting the specific protection scope of the invention.

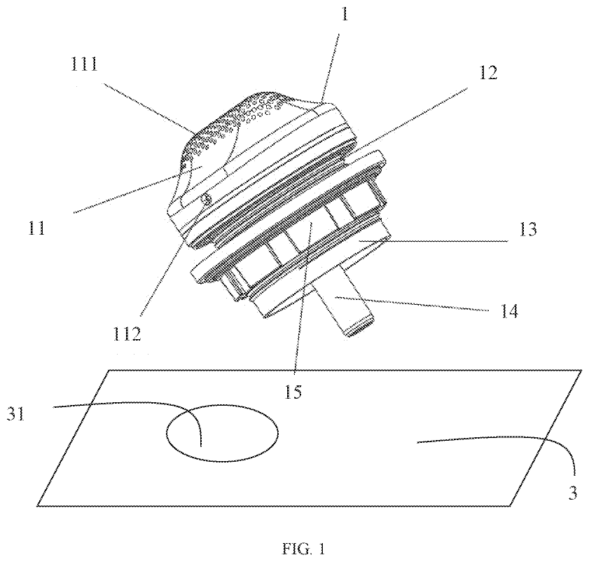

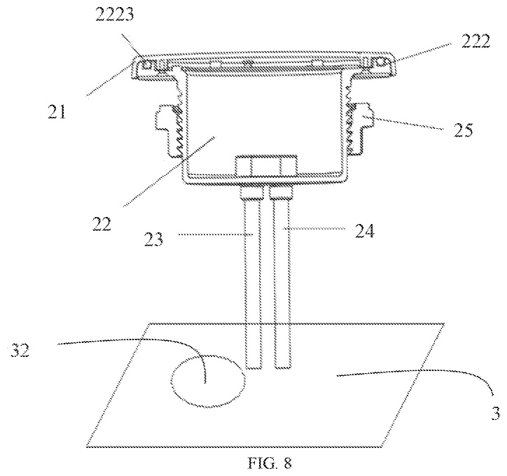

Referring to FIG. 1 and FIG. 7, a sodium hypochlorite generator comprises a sodium hypochlorite generation device 1 which is disposed in a pre-buried wall hole 31 formed in a wall 3 of a bathtub or swimming pool, and a water salinity detection device 2 electrically connected to the sodium hypochlorite generation device 1.

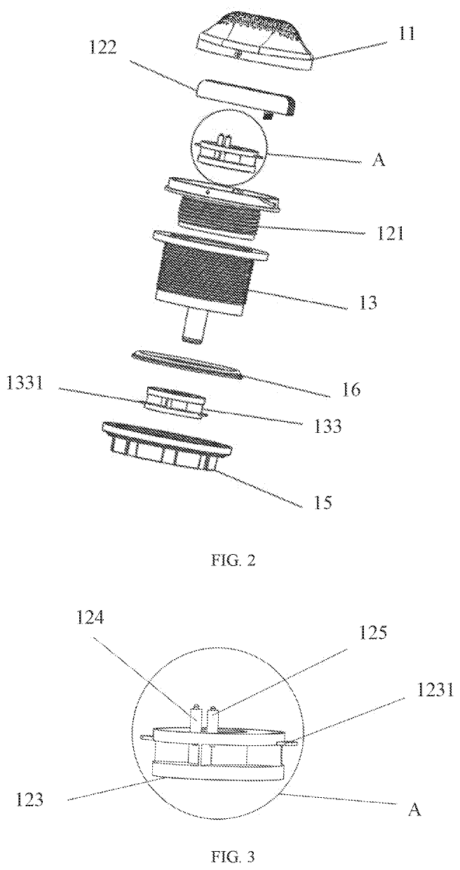

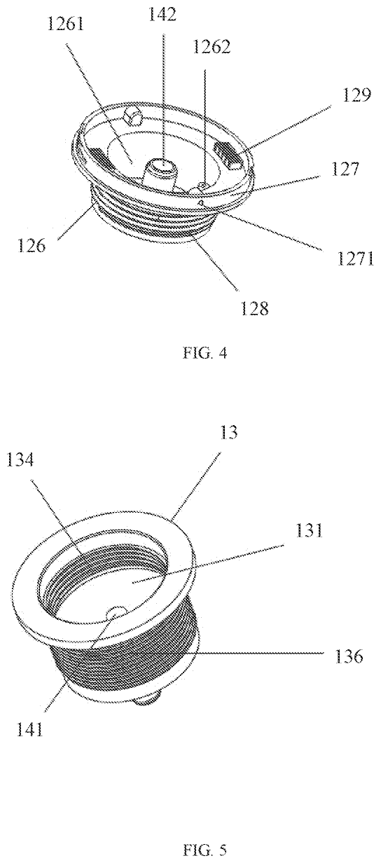

Specifically, referring to FIG. 1 to FIG. 6, the sodium hypochlorite generation device 1 comprises a cover 11, an electrode insert 12 and a base 13. A plurality of through holes 111 are formed in the cover 11. The electrode insert 12 is detachably disposed in an insert receiving cavity 131 of the base 13, and comprises an insert body 121 and a plurality of electrodes 122 mounted on the insert body 121. The cover 12 is fixedly mounted on the insert body 121, and the electrodes 122 are communicated with the outside through the cover 11. A wireless power receiving device 123 is disposed in the insert body 121. A first probe 124 and a second probe 125 are disposed on the wireless power receiving device 123, and are used for detecting and outputting a voltage between the probes immersed in a sodium chloride solution. A transmitting device receiving cavity 132 is formed in a side, opposite to the insert receiving cavity 131, of the base 13. A wireless power transmitting device 133 corresponding to the wireless power receiving device 123 is disposed in the transmitting device receiving cavity 132, and the wireless power receiving device 123 is electrically connected to the electrodes 122 and the first and second probes 124/125.

Preferably, the sodium hypochlorite generation device 1 further comprises a turbulent flow channel 14. The turbulent flow channel 14 comprises a first channel 141 disposed in the base 13 and a second channel 142 disposed in the insert body 121, and the first channel 141 is in fluidly communication with the second channel 142. The turbulent flow channel 14 allows an external water source to flow into the working space of the electrodes 122, as a turbulent flow, to disperse sodium hypochlorite generated by electrolysis in the working space of the electrodes 122 to diffuse the sodium hypochlorite out of the device, such that a better sterilization effect is realized, and the situation where the sodium hypochlorite device 1 is corroded due to an excessive high local concentration of the sodium hypochlorite is prevented.

Wherein, in this embodiment, the insert body 121 is provided with a cylinder 126 extending along one end of the base 13, and a cylinder cavity 1261 is formed in the cylinder 126 and is used for receiving the wireless power receiving device 123. Mounting grooves 129 for mounting the electrodes 122 are formed in an end, away from the base 13, of the insert body 121. The insert body 121 is provided with a protrusion 127 extending towards the cover 11, a threaded hole 1271 is formed in the protrusion 127, and a mounting hole 122 corresponding to the threaded hole 1271 is formed in the cover 11. The cover 11 is fixed on the insert body 121 through a screw extending through the through hole 122 to be fixed in the threaded hole 1271.

An external thread 128 is disposed on an outer side of the insert body 121, an internal thread 134 is disposed in the insert receiving cavity 131 of the base 13, and the insert body 121 is fixedly mounted in the base 13 through threaded connection between the external thread 128 and the internal thread 134.

An external thread 136 is disposed on the base 13, the base 13 is fixedly mounted in the pre-buried wall hole through a locking nut 135, and a sealing gasket 16 is disposed in a mounting gap between the base 13 and the pre-buried wall hole.

The wireless power receiving device 123 comprises a receiving device body and a lug 1231 integrally formed on the receiving device body, wherein a circular hole is formed in the lug 1231. A mounting hole 1262 corresponding to the circular hole is formed in the bottom of the cylinder cavity 1261. The wireless power receiving device 123 is fixed in the cylinder cavity 1261 by screws extending through the circular hole of the lug 1231 to be fixed in the mounting holes 1262. The wireless power transmitting device 133 comprises a transmitting device body and a lug 1331 integrally formed on the transmitting device body, a circular hole is formed in the lug 1331, a mounting hole 135 corresponding to the circular hole is formed in the transmitting device receiving cavity 132, and the wireless power transmitting device 133 is fixed in the transmitting device receiving cavity 132 via screws extending through the circular hole of the lug 1331 to be fixed on the mounting hole 135 of the transmitting device receiving cavity 132.

A transmitting coil and a driving circuit are disposed on the transmitting device body of the wireless power transmitting device 133, a receiving coil is disposed in the receiving device body of the wireless power receiving device 123, and the transmitting coil is arranged to be symmetrical with the receiving coil. Through the coils, electromagnetic induction between the wireless power transmitting device and the wireless power receiving device can be realized to perform wireless power transmission.

The wireless power transmitting device 133 and the wireless power receiving device 123 drive the electrodes to perform electrolysis and a product generated after electrolysis is discharged through the through holes 111, at the same time, the wireless power receiving device 123 drives the first and second probes electrically connected thereto to detect and output the voltage between the probes, and a voltage signal is transmitted to the wireless power transmitting device 133 and then transmitted by the wireless power transmitting device 133 to the water salinity detection device 2.

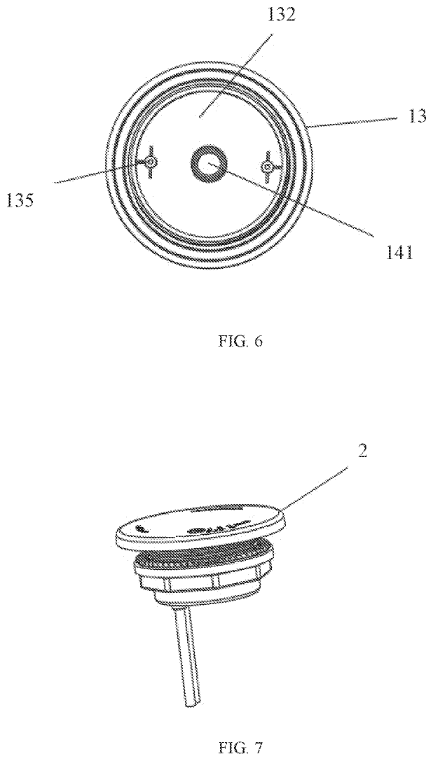

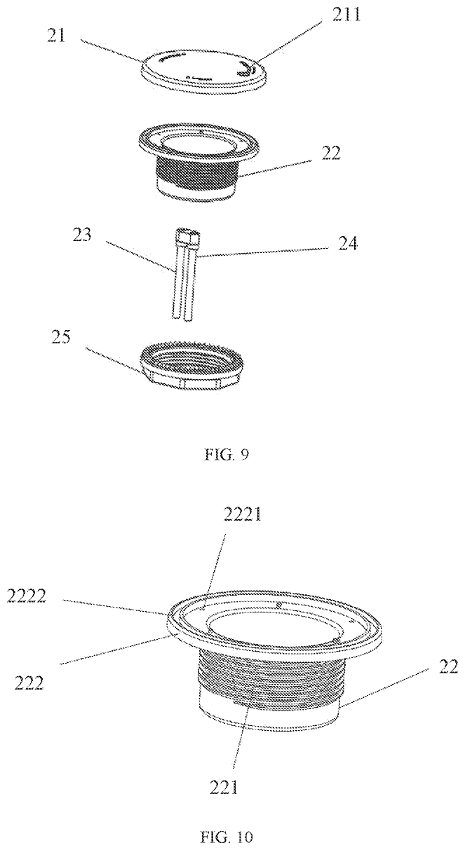

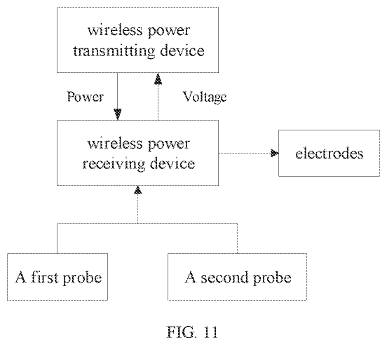

Referring to FIG. 6-FIG. 9, the water salinity detection device 2 comprises a display panel 21, a detection box 22, a power line 23 and a signal line 24, wherein a drive module (not shown) for obtaining the salinity of water according to the voltage is disposed in the detection box 22. The power line 23, one end of the signal line 24 and the display panel 21 are electrically connected to the drive module, the other end of the signal line 24 is electrically connected to the wireless power transmitting device 133 to receive the voltage signal between the first probe and the second probe and transmit the voltage signal to the drive module. The drive module obtains the salinity of water according to the received voltage signal and drives the display panel 21 to display a salinity range.

Specifically, a plurality of display lamps 211 are disposed on the display panel 21, and the plurality of display lamps 211 correspond to multiple salinity ranges respectively. For example, three display lamps corresponding to a low salinity, a medium salinity and a high salinity respectively are disposed on the display panel 21 to feed back the salinity range of water to reflect the extent of the electrolytic reaction of the sodium chloride solution.

An external thread 221 is disposed on an outer side of the detection tank 22, and the detection box 22 is fixedly mounted on a support (e.g. a pre-buried wall hole 32 formed in a wall 3) through a locking nut 25.

The detection box 22 is provided with a protrusion 222 extending towards the display panel 21, a threaded hole 2221 is formed in the protrusion 222, and the detection box 22 is fixedly connected to the display panel 21 through screws. A groove 2222 is formed in a side, close to the display panel 21, of the protrusion 222, a bottom surface of the display panel 21 abuts against and contacts with the groove 2222 to form a cavity, and a waterproof gasket 2223 is disposed in the cavity/groove 2222 to prevent water in the outside from entering the detection box 22 via a gap between the display panel 21 and the detection box 22, to ensure that the detection box 22 can work normally.

A functional relationship between the voltage signal and the salinity of water to be detected is pre-stored in the drive module, for example, the salinity of water is 3% when the voltage is 18V; and the corresponding functional relationship between the voltage signal and the salinity is obtained through a large amount of tests, and does not need to be measured later under the condition where hardware is not modified. The drive module is electrically connected to the signal line 23, one end of the power line 22 and the display panel 21, the other end of the power line 22 is connected to an external power supply to supply power to the water salinity detection device 2, the drive module receives the voltage signal detected by the first probe and the second probe from the wireless power transmitting device 133 through the signal line 23, obtains the salinity of the solution according to the pre-stored functional relationship between the voltage signal and the salinity of water to be detected, outputs a corresponding electrical signal, then drives the display panel 21 to turn on the display lamp 211 corresponding to the water salinity range, the water salinity range can be reflected by the brightness of the display lamp 211, and then the degree of electrolysis of the sodium chloride solution can be figured out to determine the extent of the electrolytic reaction.

The working principle of the sodium hypochlorite generator with a water salinity detection device provided by this embodiment is as follows: the sodium hypochlorite generation device 1 is placed in the sodium chloride solution, the sodium chloride solution enters the insert body 121 through the through apertures 211. An external power supply drives the electrodes 122 of the insert body 121 to perform electrolysis through the wireless power transmitting device 133 and the wireless power receiving device 123 and a product generated after electrolysis is discharged through the through holes 111, at the same time, the first and second probes are driven to detect and output a change of the voltage therebetween, and transmit a voltage signal to the water salinity detection device 2. The water salinity detection device 2, which is electrically connected to the sodium hypochlorite generation device 1, receives the voltage signal detected by the first and second probes from the wireless power transmitting device 133 through the signal line, and the voltage signal is processed by the drive module of the detection box 22 to obtain a corresponding water salinity range, which is then displayed by the corresponding display lamp 211 on the display panel 21.

The above embodiments are merely preferred ones of the invention. It should be pointed out that these preferred embodiments should not be construed as limitations of the invention, and the protection scope of the invention should be defined by the claims. Those ordinarily skilled in the art can make some improvements and embellishments without departing from the spirit and scope of the invention, and all these improvements and embellishments should also fall within the protection scope of the invention.

What is claimed is:

1. A sodium hypochlorite generator, comprising:
a sodium hypochlorite generation device for being disposed in a pre-buried wall hole formed in a wall, the sodium hypochlorite generation device comprising a cover, an electrode insert and a base with a receiving cavity, the electrode insert being detachably disposed in the receiving cavity of the base, the electrode insert comprising an insert body and a plurality of electrodes mounted on the insert body, the cover being fixedly mounted on the insert body; and
a water salinity detection device electrically connected to the sodium hypochlorite generation device, the water salinity detection device comprising a display panel, a detection box, a power line and a signal line;
wherein a wireless power receiving device is disposed in the insert body, a first probe and a second probe are disposed on the wireless power receiving device for detecting and outputting a voltage between the first and second probes;
a wireless power transmitting device corresponding to the wireless power receiving device is disposed in the base; and
a drive module configured for obtaining the salinity of water according to the voltage is disposed in the detection box, the power line, one end of the signal line and the display panel are electrically connected to the drive module, the other end of the signal line is electrically connected to the wireless power transmitting device for receiving a voltage signal between the first probe and the second probe and transmitting the voltage signal to the drive module.

2. The sodium hypochlorite generator with a water salinity detection device according to claim 1, wherein a plurality of display lamps are disposed on the display panel and are used for indicating a salinity range of water.

3. The sodium hypochlorite generator with a water salinity detection device according to claim 1, wherein the detection box is provided with a protrusion extending towards the display panel, threaded holes are formed in the protrusion, and the detection box is fixedly connected to the display panel through screws fixed in the threaded holes.

4. The sodium hypochlorite generator with a water salinity detection device according to claim 3, wherein an external thread is disposed on an outer side of the detection box, and the detection box is for being fixedly mounted to a support through a locking nut.

5. The sodium hypochlorite generator with a water salinity detection device according to claim 3, wherein a groove is formed in a side, close to the display panel, of the protrusion, a bottom surface of the display panel abuts against and contacts with the groove to form a cavity, and a waterproof gasket is disposed in the cavity.

6. The sodium hypochlorite generator with a water salinity detection device according to claim 1, wherein a transmitting device receiving cavity is formed at a side, opposite to the insert receiving cavity, of the base, and the wireless power transmitting device is disposed in the transmitting device receiving cavity.

7. The sodium hypochlorite generator with a water salinity detection device according to claim 1, wherein the wireless power receiving device is electrically connected to the electrodes, the first probe and the second probe such that an external power supply is capable of driving the electrodes to perform electrolysis through the wireless power transmitting device and the wireless power receiving device, and synchronously drives the first probe and the second probe to detect and output the voltage between the first probe and the second probe.

8. The sodium hypochlorite generator with a water salinity detection device according to claim 1, wherein the sodium hypochlorite generation device further comprises a turbulent flow channel which penetrates through the base and the insert body to be communicated with a working space of the electrodes.
